(19) United States
(12) Patent Application Publication
(10) Pub. No.: US 2025/0338831 A1
(43) Pub. Date: Nov. 6, 2025

(54) Carpenter Bee Trap with Catch and Release Functionality

(71) Applicant: Clifford Warren Davis, JR., Fairhope, AL (US)

(72) Inventor: Clifford Warren Davis, JR., Fairhope, AL (US)

(21) Appl. No.: 19/199,610

(22) Filed: May 6, 2025

Related U.S. Application Data
(60) Provisional application No. 63/642,914, filed on May 6, 2024.

(51) Int. Cl. A01K 57/00; A01M 1/10

(52) U.S. Cl. CPC A01K 57/00; A01M 1/106

(57) ABSTRACT

The present disclosure provides a bee trap with an entrance unit and a catch basin.

### CROSS REFERENCE TO RELATED APPLICATIONS

This application claims priority to, and the benefit of, pending U.S. Provisional Patent Application No. 63/642,914 filed May 6, 2024.

### FIELD OF THE INVENTION

The invention relates generally to devices for controlling insects. More specifically, the invention relates to a carpenter bee trap with a side mounted containment vessel.

### BACKGROUND ART

Carpenter bees (the genus Xylocopa in the subfamily Xylocopinae) are large bees distributed worldwide. There are some 500 species of carpenter bee in 31 subgenera. Their name comes from the fact that nearly all species build their nests in burrows in dead wood, bamboo, or structural timbers.

Carpenter bees are traditionally considered solitary bees, though some species have simple social nests. Carpenter bees make nests by tunneling into wood, vibrating their bodies as they rasp their mandibles against the wood, each nest having a single entrance which may have many adjacent tunnels. The entrance is often a perfectly circular hole measuring about 16 mm (0.63 in) on the underside of a beam, bench, or tree limb. Since a carpenter bee nest is destructive to wooden structures, a simple and effective carpenter bee trap is needed.

### SUMMARY OF THE INVENTION

In some aspects, present disclosure provides a bee trap with an entrance unit and a catch basin. Other aspects and advantages of the invention will be apparent from the following description and the appended claims.

### BRIEF DESCRIPTION OF DRAWINGS

It should be noted that identical features in different drawings are shown with the same reference numeral.

FIG. 1 shows a front perspective view of one embodiment of the present invention.

FIG. 2 shows a front view of one embodiment of the present invention.

FIG. 3 shows a side view of one embodiment of the present invention.

FIG. 4 shows a rear view of one embodiment of the present invention with the closing means in one position.

FIG. 5 shows a rear view of one embodiment of the present invention with the closing means in the opposite position of FIG. 4.

FIG. 6 shows a top view of one embodiment of the present invention.

FIG. 7 shows a bottom view of the entrance unit of one embodiment of the present invention.

FIG. 8 shows a top view of the catch basin of one embodiment of the present invention with the closing mechanism in the closed position.

FIG. 9 shows a top view of the catch basin of one embodiment of the present invention with the closing mechanism in the open position.

### DETAILED DESCRIPTION

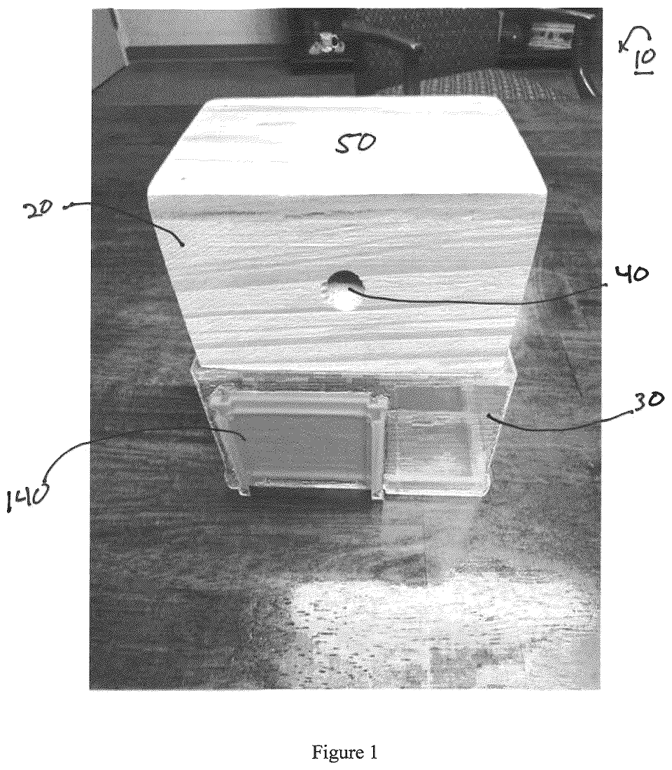

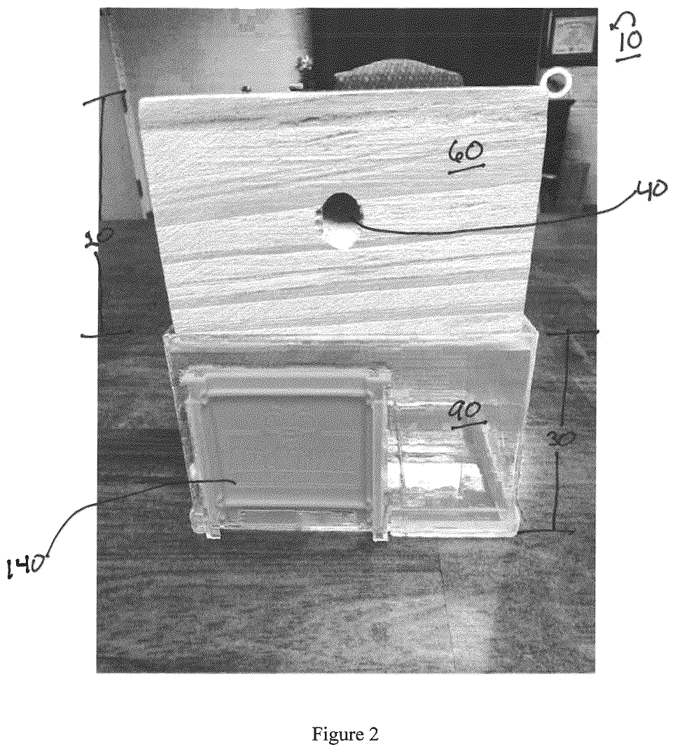

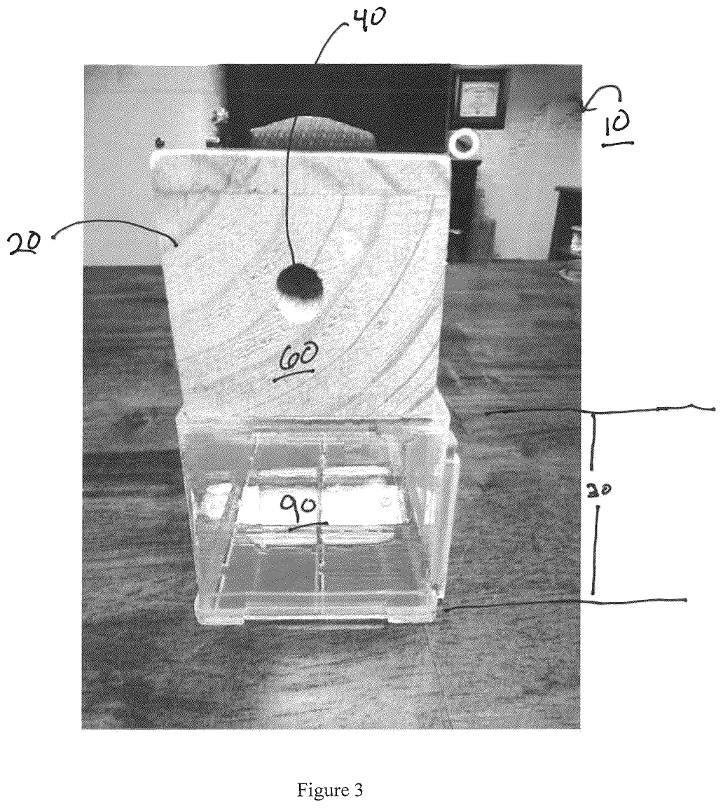

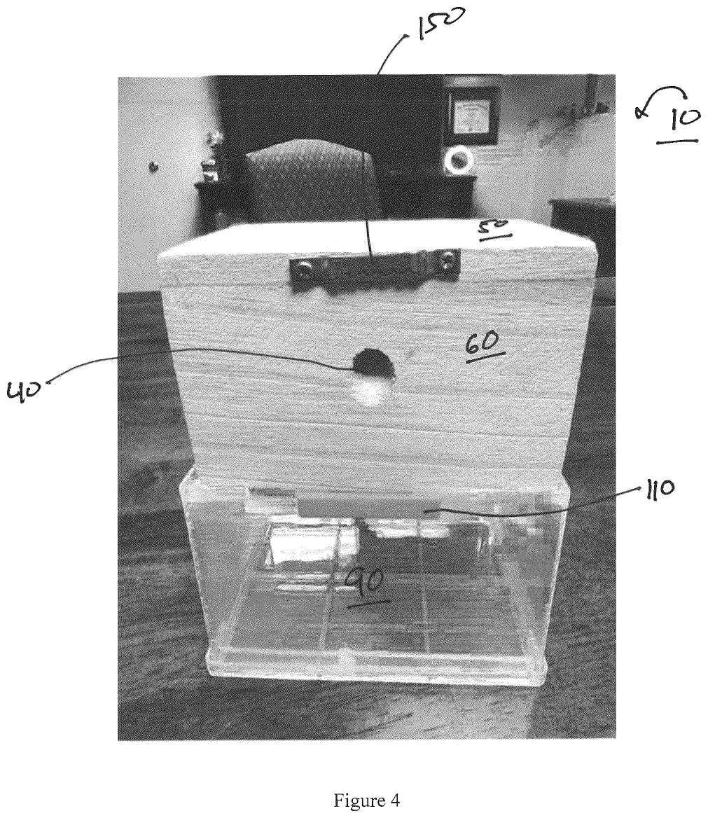

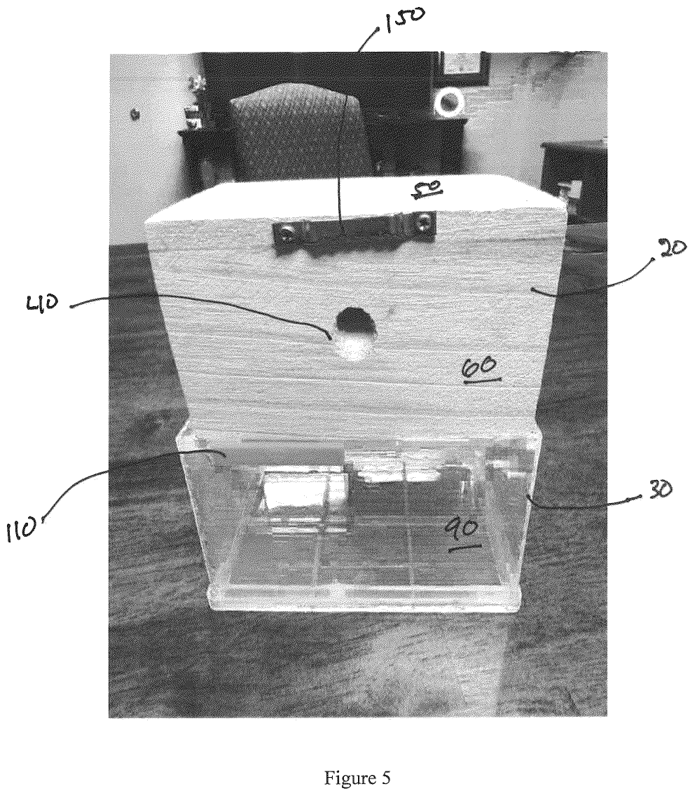

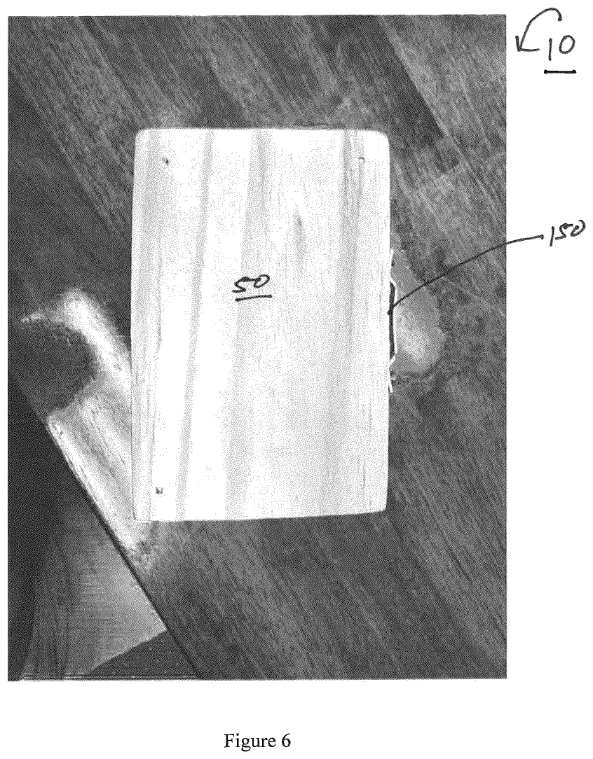

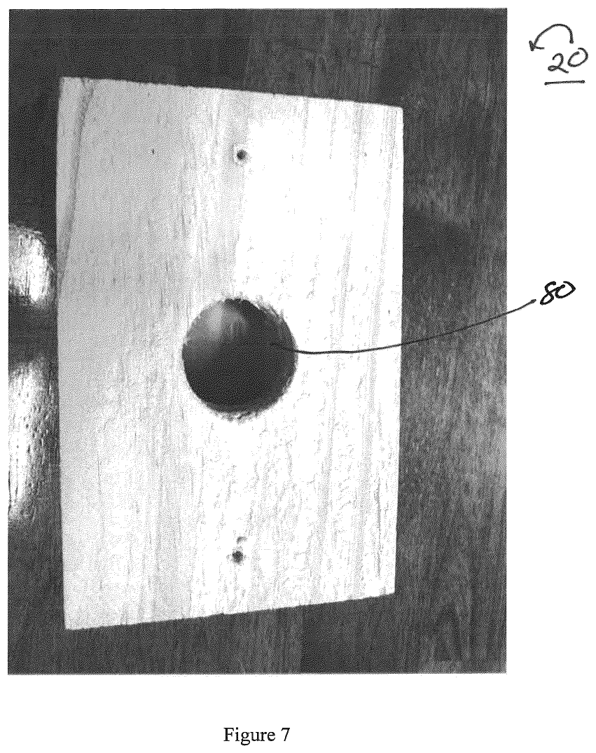

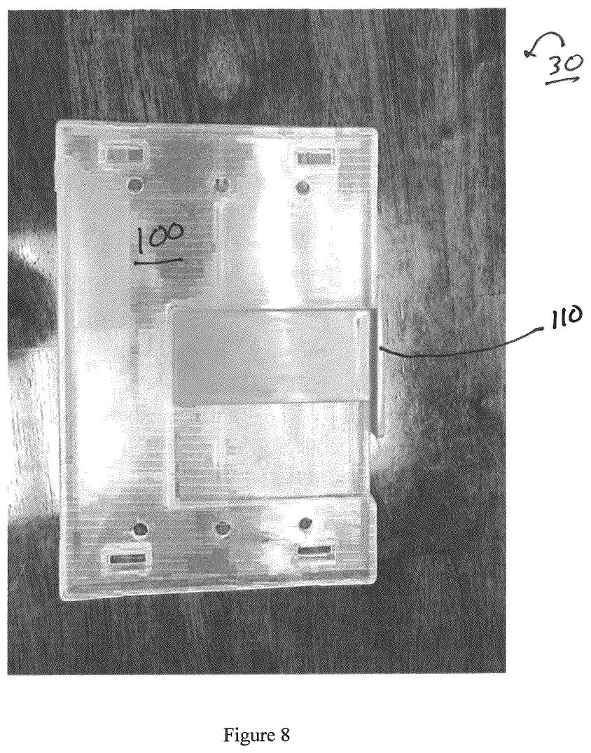

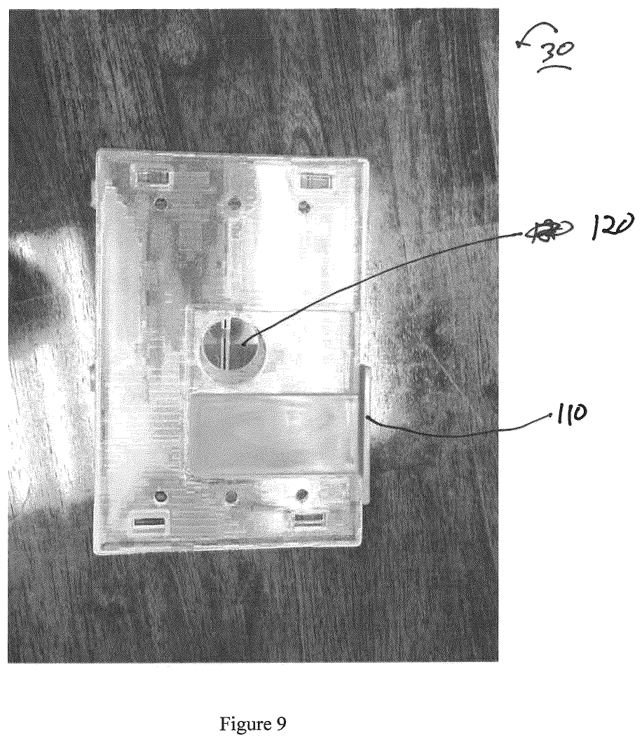

Now referring to FIGS. 1-9, the present disclosure provides a bee trap 10 with an entrance unit 20 and a catch basin 30.

The entrance unit 20 comprises one or more bee tunnels 40, a top 50, a bottom 55 and sides 60. Generally, the entrance unit 20 is four (4) sided, such as a rectangle, but other shapes should be considered with the scope of this disclosure. In one embodiment, the top 50, a bottom 55 and sides 60 all come together to form a generally rectangular shaped structure with a hollow interior. Also shown is a bee opening 40 that allows a carpenter bee to enter the interior of the entrance unit 20.

The bee tunnels 40 may be present on one (1) or more sides 60 of the entrance unit 20. The bee tunnels 40 generally circular in shape and have a diameter between 3/8″ and 1/2″ which is the natural size of carpenter bee holes. The bee tunnel 40, optionally, may angle upward at an angle between 45°-50° into the interior of the entrance unit 20. The upward angle allows some light into the interior of the trap while avoiding direct sunlight shining into the trap. In one embodiment, one side 60 may include a plurality of bee tunnels 40.

The entrance unit 20, optionally, may include a hanging means 70, secured to the entrance unit 20 which allows the bee trap 10 to be hung or supported by a nail, screw, or other similar means. The entrance unit 20 also includes a passage 80 allowing passage of a trapped bee from the entrance unit 20 to the catch basin 30. The entrance unit 20 is, in one embodiment, made from wood such light is not allowed to enter the entrance unit 20 exempt via the bee tunnels 40. A variety of types of wood could be used to construct the trap as long as the wood is a type that is attractive to carpenter bees. Additionally, a plastic or a wood substitute material could be used for the entrance unit 20 as well.

The catch basin 30, in one preferred embodiment, is made from a clear or translucent material, such as a plastic. The catch basin 30 has sides 90, a top 100, a closing mechanism 110, a complimentary passage 120, a releasing door 140 and a bottom 130. Again, the sides 90, top 100 and bottom 130 all come together to form a generally rectangular shaped structure with a hollow interior. It is noted, however, that other shapes should be considered within the scope of this disclosure.

The catch basin 30 preferably is made from a clear or translucent material to take advantage of a carpenter bee's natural attraction towards sunlight such that when a bee enters the entrance unit 20 it attempts to escape by passing through the passage 80 and the complimentary passage 120 into the catch basin 30.

Once in the catch basin 30, prior art carpenter bee traps generally resulted in the death of the trapped bee. The present disclosure, however, provides a new and novel mechanism to allow for the release of trapped bees as will be discussed herein. In operation, the trap is mounted hung or sat on a structure and left in place. The carpenter bees are attracted to the bee openings as they resemble of natural bee hole. Once inside the interior, the bees are trapped. The bees will generally attempt to escape by moving towards light, i.e., into the clear or translucent catch basin 30. Once a suitable number of bees have been trapped, a user can choose, if they like, to release the bees in a more suitable location. If the user decides to release the trapped bees, they can move the closing mechanism 110 on the catch basin 30 from the open position to the closed position. In the closed position, the closing mechanism 110 blocks the bees' movement from the entrance unit 20 to the catch basin 30 via the passage/complimentary passage 120. Then, the user can transport the entire bee trap 10 to the desired area for releasing the bees. The releasing mechanism then can be moved from the closed position to the open position allowing the bees to leave the catch basin 30. The inverse of the above steps can be followed to return the bee trap 10 to its normal location and into its trapping functionality.

In one embodiment the entrance unit 20 and catch basin 30 may be manufactured as one piece and may be manufactured from plastic (or similar material) such that the entrance unit 20 and catch basin 30 are inseparable. In another embodiment, the entrance unit 20 and catch basin 30 are separate pieces that may be separated such that when the catch basin 30 is full of bees, the closing mechanism and releasing mechanism may be closed and just the catch basin 30 is transported to the area where it is desirable to release the trapped bees the manner described above.

In one embodiment, the closing mechanism 110 is a slide, movable horizontally by the user from the open to closed position (and vice versa). In one embodiment, the releasing mechanism 140 is similarly a sliding door moveable vertically from an open to closed position (and vice versa). However, other modes of movement should be considered within the scope of this disclosure such as a swinging or hanging type movement.

While the invention has been described with respect to a limited number of embodiments, those skilled in the art, having benefit of this disclosure, will appreciate that other embodiments can be devised which do not depart from the scope of the invention as disclosed here. Accordingly, the scope of the invention should be limited only by the attached claims.

What is claimed is:

1. An insect trap comprising an entrance unit with at least one bee tunnel providing access to the interior of the entrance unit and a passage to a clear catch basin, wherein the catch basin comprises a closing mechanism and a releasing door.

2. The insect trap of claim 1 wherein the closing mechanism is moveable in a horizontal motion to close the passage.

3. The insect trap of claim 1 wherein the releasing door is moveable in a vertical motion and allows insects in the catch basin to be released alive.

4. The insect trap of claim 3 wherein the closing mechanism is moveable in a horizontal motion to close the passage.

5. The insect trap of claim 1 wherein the entrance unit is manufactured from wood.

6. The insect trap of claim 3 wherein the entrance unit is manufactured from wood.

7. The insect trap of claim 1 comprising at least two bee tunnels.

8. The insect trap of claim 3 comprising at least two bee tunnels.

9. The insect trap of claim 6 comprising at least two bee tunnels.

10. The insect trap of claim 1 wherein the entrance unit and the catch basin are generally rectangular in shape.

11. The insect trap of claim 9 wherein the entrance unit and the catch basin are generally rectangular in shape.

12. The insect trap of claim 1 wherein the bee tunnels have a diameter between ⅜″ and ½″.

13. The insect trap of claim 11 wherein the bee tunnels have a diameter between ⅜″ and ½″.

14. The insect trap of claim 1 wherein the catch basin is manufactured from plastic.

15. The insect trap of claim 11 wherein the catch basin is manufactured from plastic.
